(19) United States
(12) Patent Application Publication
(10) Pub. No.: US 2009/0172949 A1
(43) Pub. Date: Jul. 9, 2009

(54) Spork

(76) Inventor: Gabriele Pollard Watts, Evans, GA (US)

Correspondence Address: Gabriele Pollard Watts, 5036 Hardy McManus Road, Evans, GA, 30809, US

(21) Appl. No.: 11/826,542

(22) Filed: Jul. 16, 2007

Related U.S. Application Data
(60) Provisional application No. 60/831,406, filed on Jul. 15, 2006.

(51) Int. Cl. A47J 43/28

(52) U.S. Cl. 30/150

(57) ABSTRACT

I, Gabriele Pollard Watts, have invented and designed the “Spork”. This invention is an easy to use, double sided eating utensil. The design is, a spoon on one end facing up and a fork on the other end faced down. That way, it only requires a flip backwards to use either side.

### BACKGROUND OF THE “SPORK”

I, Gabriele P. Watts, at the age of 13, thought of a clever idea. I started to think about, what if there was a way to combine two often used eating utensils into one? Fortunately, there was a way. Thus, in early 2006, the idea of the “Spork” came about. Gertrude J. Watts (Mother & Guardian) helped me with this newfound idea. Over time, the new idea began to take form. Now it is a full-fledged invention!

The “Spork” took it's roots from the modern day spoon and fork. Back then, people used the spoon and fork for eating purposes, and to this day they still do, but what people didn't seem themselves was, could we combine these two together? Well, I've answered that question and the answer is yes! You can combine the two to create a much better eating utensil. Just think of the problems it can solve. When you're eating food that requires a spoon and a fork, you won't have to have two eating utensils on your plate. Also, most importantly, no more having to buy separate cases of spoons and forks!

### BRIEF SUMMARY OF THE “SPORK”

To be brief, the “Spork” is a two-sided eating utensil. It is very unique because it's one of a kind. Now, people uses the common spoon and fork to eat with, but they're separated. The Spork is a spoon and fork combined to make one. The reason why I thought of the “Spork” was, I thought people would get tired of having to use the spoon and fork separately. It's safe to say that I've never seen a person eating with a two-sided eating utensil.

As stated in THE BACKGROUND OF THE SPORK, the “Spork” solves two problems. The problem of having two eating utensils on your plate at the same time, and the problem of having to buy separate cases of spoons and forks. It doesn't seem like much, but if you think about it, it solves two big problems.

### BRIEF DESCRIPTION OF THE DRAWINGS

In the drawings:

FIG. 1 is showing the “Spork” with the fork in the upward position and the spoon in the downward position.

FIG. 2 is showing the spoon in the upward position and the fork in the downward position.

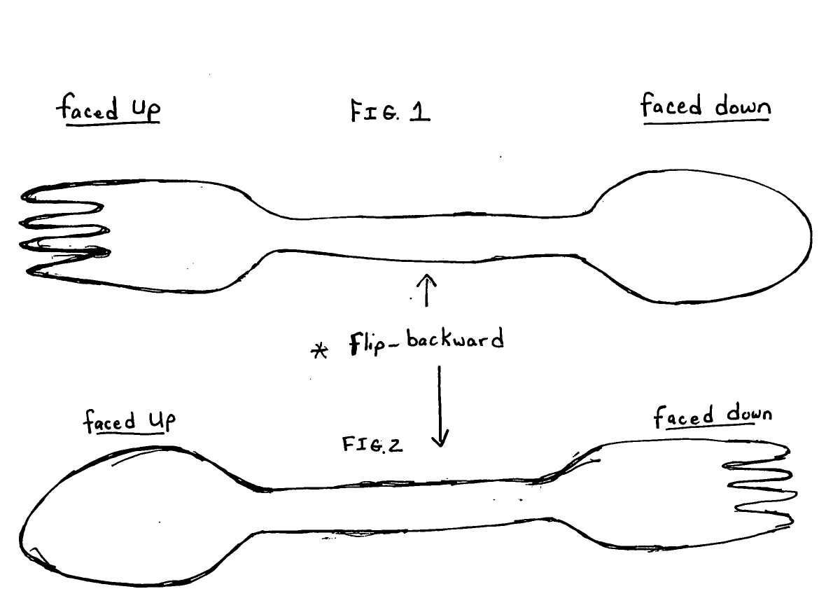

In between the two drawings are two arrows, one facing up and the other one facing down. It is demonstrating the one step process between FIGS. 1 and 2, that it only requires a flip backwards.

### DETAILED DESCRIPTION OF THE “SPORK”

As you might be wondering, why name this invention the “Spork”? Well, good question, since the spoon and fork are two different household eating utensils, I decided to combine the two names just like I combined the spoon and fork.

Back in early times, inventors came up with the spoon and fork to aid people in eating, like previously explained, what they didn't seem to figure out was . . . what if you can have just one utensil instead of two. In, some cases, one is better than two and in this case, one is definitely better.

What I thought was, since the spoon and fork are always used in households, why not combine them together. That way, people won't have to buy two different cases of spoons and forks; they can just buy one case altogether. And guest what? The “Spork” can also be used with its partner, the knife! I believe in the future that the “Spork” would be used worldwide.

As you see in the drawing, FIG. 1 is illustrating the fork faced up and spoon faced down; and in FIG. 2, the spoon is faced up and the fork is faced down. (Explained in the BRIEF DESCRIPTION OF THE DRAWINGS) Why is that? Well, since the fork is faced up in FIG. 1, its ready for use! When you're ready to use the spoon just flip the utensil backwards using your thumb, middle, and index fingers and then the spoon is facing up. It only requires a one step process!

Since the “Spork” is so easy to use, it can be used just about anywhere. Some examples of where this invention can be used are: On picnics, birthday parties, and for eating breakfast, lunch, and dinner at home or at a restaurant. The “Spork” is a great idea and can be use for every eating occasion!

When it comes to cleaning the “Spork”, no problem, the plastic “Spork” can be washed by hand and the “Spork” made of silverware can be washed by hand or dishwasher!

1. I, Gabriele Pollard Watts claim as my invention, the eating utensil known as the “Spork”, which is a spoon and a fork combined to make one.

2. I, Gabriele Pollard Watts, claim that the “Spork” is composed of:
a fork on one end facing up and a spoon on the other end facing down, it comes in three sizes; the teaspoon/standard fork size, tablespoon/fork size, and the serving spoon/fork size, the total length of the “Spork” ranges from 7.0 to 10.50 inches, and made in plastic and silverware.
